(19) United States
(12) Patent Application Publication
(10) Pub. No.: US 2001/0021751 A1
(43) Pub. Date: Sep. 13, 2001

(54) Resin composition made from glyoxylic acid and a hydroxy group-containing polymer

(76) Inventors: Jan Andre Jozef Schutyser, Dieren (NL); Dirk Emiel Paula Mestach, Nijlen (BE)

Correspondence Address: Joan M. McGillycuddy, Akzo Nobel Inc., Intellectual Property Department, 7 Livingstone Avenue, Dobbs Ferry, NY, 10522-3408, US

(21) Appl. No.: 09/740,774

(22) Filed: Dec. 19, 2000

(30) Foreign Application Priority Data
Dec. 22, 1999 (EP) 99204466.9

(51) Int. Cl. C08L 33/10

(52) U.S. Cl. 525/227

(57) ABSTRACT

The invention pertains to a cross-linkable resin composition which is obtainable from the reaction of glyoxylic acid and a hydroxy and/or epoxy group-containing polymer in the absence of amino-containing cross-linkers, characterized in that 0.05-0.6 mole equivalent of glyoxylic acid is used per mole hydroxy group, with the epoxy groups being calculated as two hydroxy groups. The composition can be cross-linked at room temperature, is non-toxic, and is not susceptible to yellowing.

This application claims priority of European Patent Application No. 99204466.9, filed on Dec. 22, 1999.

The invention pertains to cross-linkable resin compositions which are obtainable from the reaction of glyoxylic acid and a hydroxy and/or epoxide group-containing polymer.

### BACKGROUND OF THE INVENTION

Polymers that are used as binders in the preparation of compositions such as coatings, printing inks, adhesives, paper additives, and the like usually require that a cross-linking reaction occurs after the application of the composition.

This cross-linking reaction is necessary to obtain desired properties such as mechanical strength, resistance against chemical agents, durability, et cetera.

The cross-linking is often the result of the reaction between functional groups on the polymer and co-reactive functional groups on a cross-linker added to the composition. Examples are the reaction between the hydroxy groups of a polymer and melamine-formaldehyde resins or between hydroxy groups and polyisocyanate resins.

When the composition needs to remain stable as a one-component system, it is necessary to select cross-linkers with very low reactivity at ambient temperature. If the reactivity is too high, the composition will start to cross-link even before it is applied onto the substrate. Therefore, compositions are made the cross-linking reaction of which usually occurs at elevated temperatures. These elevated temperatures are required to increase the reactivity of the cross-linker or else to remove the blocking groups used to diminish said reactivity.

However, it would be beneficial, and in fact for certain applications it is mandatory, to have stable cross-linkable compositions that nevertheless are able to cross-link at room temperature. Such stable one-component systems have been described as having the ability to cross-link at room temperature after evaporation of the liquid carrier. In these systems the liquid carrier effectively blocks the cross-linking reaction. Examples of such reactive systems are aldehyde or ketone groups that react with hydrazides or hydroxylamines. In other systems the reactive groups are blocked by a volatile base. Acetoacetoxy groups that are converted to the corresponding enamine with ammonia will react with polyamines when the composition is applied and the ammonia is allowed to evaporate. Another possibility is to physically separate the functional groups, for example by means of steric hindrance, rendering the cross-linking reaction impossible before the composition is dried. An example of this is the reaction of a polymer dispersion with ethylene urea groups that react with a second polymer dispersion modified with aldehyde or acetal groups. However, all these reactive systems suffer from a major disadvantage, i.e. that the functional groups in the polymer and/or in the cross-linker must contain nitrogen atoms.

The presence of nitrogen atoms in the cross-link bonds makes the cross-linked composition susceptible to yellowing on exposure to certain chemicals and on aging. This yellowing is highly undesirable.

Another disadvantage of nitrogen atom-containing cross-linkers is the toxic nature of most of these compounds. The possibility of residual nitrogen-containing cross-linker migrating can render a composition unsuitable for use in applications where direct or indirect food contact is possible.

On the other hand, nitrogen-free cross-linkers are known, but they require hardening temperatures well above room temperature. Such a cross-linker has been disclosed in German patent DE 2,944,025, where glyoxylic acid is used as cross-linker for hydroxy group-containing polymers. It is described that 70 to 120% of glyoxylic acid is required with respect to the hydroxy value of the polymer. Under these conditions lower hardening temperatures at short hardening times are possible. Nevertheless, the hardening temperature still is 100° C. at 60 sec. There is a need for further improvement, one where non-toxic cross-linkers can be used at room temperature, giving a product that is resistant to yellowing.

### SUMMARY OF THE INVENTION

The present invention has for its object to provide a stable one-component composition that is able to cross-link at ambient temperature without the use of nitrogen-containing cross-linkers. The present invention therefore pertains to a cross-linkable resin composition which is obtainable from the reaction of glyoxylic acid and a hydroxy and/or epoxy group-containing polymer in the absence of amino-containing cross-linkers, characterized in that 0.05-0.6 mole equivalent of glyoxylic acid is used per mole hydroxy group, with the epoxy groups being calculated as two hydroxy groups.

### DETAILED DESCRIPTION OF THE INVENTION

Preferably 0.15-0.45 mole equivalent, more preferably 0.20-0.35 mole equivalent, of glyoxylic acid is used per mole hydroxy group.

The main polymer comprises oxirane (epoxy) and/or hydroxy-functional groups. These groups can be introduced into the polymer by several techniques. If the polymer is prepared by means of radical polymerization, the following functional monomers can be used:

Hydroxy-Functional Monomers:

Hydroxyethyl(meth)acrylate, hydroxypropyl(methacrylate), hydroxybutyl(meth)acrylate, esters of di- or trialkylene glycols, adducts of acrylic or methacrylic acid with epoxy-functional compounds, such as glycidyl versatate (Cardura™ E-10), or other glycidyl-functional materials.

Oxirane-Functional Monomers:

Glycidyl(meth)acrylate, allyl glycidyl ether, or monomers wherein the oxirane group is separated from the ethylenically unsaturated bond by a spacer. Such monomers can be prepared by the reaction of suitable hydroxy-functional monomers with epichlorohydrin, followed by removal of hydrochloric acid and subsequent ring-closure to the oxirane.

Furthermore, monomers having a cycloaliphatic oxirane group can be used. These monomers have the following structure:

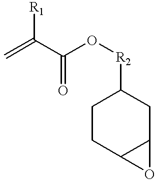

R₁=CH₃ or H

R₂=—(CH₂CH₂)ₙ—, —(CH₂CH₂O)ₙ—, or —[CH(CH₃)CH₂O]ₙ—, wherein n=1-30 and which group is attached to the ethylenically unsaturated carboxylate moiety through a carbon atom.

Besides these functional monomers, the polymer can contain monomers selected from the esters of acrylic or methacrylic acid, such as methylmethacrylate, butyl(meth)acrylate, 2-ethylhexyl(meth)acrylate, ethylacrylate, vinylic monomers such as styrene, vinyl toluene, and vinyl acetate.

The copolymer can also contain minor amounts of monomers with a second functionality other than hydroxy or oxirane.

Preferably, the hydroxy and/or epoxy group-containing polymer is a (meth)acrylate polymer.

The radical polymerization can be carried out by means of different techniques, which are known in the art. Solution polymerization in an organic solvent or in a mixture of organic solvents using peroxides, hydroperoxides, or azo-initiators is one way to prepare the binders of this invention.

If the composition is water borne, emulsion polymerization of the monomers in the presence of a surface-active material and an initiator that generates free radicals in water is a convenient preparation method. Alternatively, the copolymer can be prepared in an organic solution and subsequently emulsified in water.

The glyoxylic acid in the prescribed amounts can be added to the polymer immediately after its preparation or simultaneously with the composition's preparation. The glyoxylic acid may be added neat or in combination with an organic solvent to better dissolve it in the liquid medium. Glyoxylic acid is usually used as a commercially available aqueous solution, for instance as a 50% solution.

The curable compositions of the present invention may optionally further comprise a curing catalyst. For the reaction of the hydroxy groups of the binder with the hydroxy and carboxyl groups of the glyoxylic acid monohydrate use is made of catalysts, including sulfonic acids, such as para-toluene sulfonic acid, aryl, alkyl, and aralkyl acid phosphates, mineral acids, such as sulfuric acid, and fluorinated acids such as trifluoroacetic acid and trifluoromethane sulfonic acid. Metal chelate complexes such as aluminum tris(acetylacetonate) or titanium bis(acetylacetonate) are useful catalysts to promote the reaction of the carboxyl group of glyoxylic acids with the epoxy groups of the binder. The weight % of the curing catalyst, if present, is in the range from about 0.01 to about 3 weight %, based on the total solids of the binder and cross-linker.

The following examples illustrate the invention.

### EXAMPLE 1

Solvent Borne Acrylic Resin with Oxirane and Hydroxyl Groups

A round-bottomed flask was charged with 2,060 g of xylene. Cumene hydroperoxide (100 g) dissolved in 35 g of xylene was added by means of a membrane pump. 43.5 g of xylene were used to rinse the pump and the feed lines. In a separate container a monomer mixture was prepared consisting of:

| | |
|---|---|
| styrene | 1,318 g |
| hydroxyethyl methacrylate | 329 g |
| butyl acrylate | 1,407 g |
| glycidyl methacrylate | 1,000 g |

The mixture of xylene and cumene hydroperoxide was heated to reflux (±140° C.) and the monomer mixture was dosed to the flask with a membrane pump over a period of 90 min. Xylene (52.2 g) was used to rinse the pump and the feed lines. After the addition was completed, the batch was held at reflux temperature for an additional 3 h.

The batch was then cooled down to 110° C. and 385 g of xylene and 194 g of n-butanol were added. The resin solution was filtered and stored in a container for use in Example 4.

### EXAMPLE 2

Water Borne Polymer Dispersion with Oxirane and Hydroxyl Groups

A reactor was charged with the following ingredients: 323.1 g of demineralized water, 8.21 g of Igepal™ CO-897 (nonylphenol polyethylene oxide with 40 moles of ethylene oxide, ex Rhodia) and 12.52 grams of Trigonox™ AW-70 (70% aqueous solution of tert-butyl hydroperoxide, ex Akzo Nobel). The reactor was heated to 65° C. under a nitrogen blanket. At 65° C. a mixture of 8.5 g of styrene and 10.6 g of butyl acrylate was added to the reactor. Subsequently, a solution of 0.3 g of sodium formaldehyde sulfoxylate in 8.3 g of water was added to the reactor. In the meantime a monomer pre-emulsion was prepared in a separate container using the following ingredients in grams.

| | |
|---|---|
| Demineralized water | 400.6 |
| Igepal - CO-897 ™ | 41.8 |
| Poly(vinylpyrrolidon) (molecular weight 30000) | 4.4 |
| Styrene | 312.4 |
| hydroxyethyl methacrylate | 70.3 |
| butyl acrylate | 243.8 |
| glycidyl methacrylate | 215.2 |
| 2-mercaptoethanol | 18.4 |

This pre-emulsion was added to the reactor over a period of 3 h. Simultaneously, the addition of a solution of 4.3 g of sodium formaldehyde sulfoxylate in 131.1 g of water was started. The addition of this mixture was completed in 4 h. After the additions were completed, the batch was kept at 65° C. for an additional 15 min. The batch was then cooled to room temperature (R.T.) and filtered. The polymer dispersion was stored in a container for use in Examples 3 and 5.

The polymer dispersion thus obtained had the following properties: solids content 50.0%, particle size 165 nm, pH 8.6. Size exclusion analysis on the polymer gave the following results: Mn 2,661; Mw 6730 (relative to polystyrene standards).

### EXAMPLE 3

In a reaction flask 40 g of the water borne dispersion of Example 2, containing 1.61 meq epoxy groups/g solids and 0.58 meq hydroxy groups/g solids, to a total of 3.80 meq hydroxy groups per gram, were mixed with 3.60 g of a 50% aqueous solution of glyoxylic acid. The molar % of glyoxylic acid applied relative to the total of hydroxy groups was 32%. The dispersion was stirred gently for 5 h at 50° C. and then stirred at 70° C. for 3 h more after the addition of 200 mg of aluminum trisacetylacetonate. After cooling down to room temperature, the dispersion as such was subjected to coating experiments.

Using a 120 micron doctor's blade, the dispersion was applied onto glass plates and subsequently cured to clear films under the conditions mentioned in Table 1.

Spot tests on the films were carried out by contacting the film with a small wad of cotton wool completely soaked in solvent for 1 to 5 minutes. After the removal of the cotton wool, the spot was swept dry with a tissue and the damage to the film was visually observed.

In Table 1 the reference sample 1 was the dispersion prepared as described in Example 2. Reference sample 2 was a mixture of 40 g of the dispersion of Example 2 to which 200 mg of the aluminum (trisacetylacetonate) were added.

TABLE 1

| | | Persoz | Solvent spot tests | |
|---|---|---|---|---|
| | Curing | hardness | methylethyl | |
| Example | conditions | (s) | ketone | xylene |
| 3 | 30 min at 140° C. | 320 | Resistant | Resistant |
| Reference 1 | 30 min at 140° C. | 135 | Blister | Blister |
| 3 | 1 h at 80° C. | 300 | Slight stain | Resistant |
| | | | formation | |
| Reference 1 | 1 h at 80° C. | 111 | Blister | Blister |
| Reference 2 | 1 h at 80° C. | 130 | Blister | Blister |
| 3 | 1 day at R.T. | 107 | | |
| | 2 days | 172 | | |
| | 5 days | 258 | | |
| | 7 days | 268 | | |
| | 21 days | 277 | | Resistant |

### EXAMPLE 4

The solvent borne solution of Example 1 having a solid content of 60% was used. The solution contained 1.75 meq of epoxy/g of solids and 0.62 meq of hydroxy groups/g of solids, to a total amount 4.12 meq hydroxy groups per g solids.

Table 2 shows the Persoz hardness values and the appearance of the films after 7 days at R.T. obtained for different ratios of glyoxylic acid (=GA) applied versus the total of hydroxy groups of the binder. The films were prepared as mentioned in Example 3.

TABLE 2

| | Molar % | | | | |
|---|---|---|---|---|---|
| | glyoxylic | | Persoz hardness (s) | | |
| | acid versus | | at r.t. | | |
| | hydroxy | Appear- | | after | after |
| Added to 20 g solution | groups of | ance | after | 7 | 14 |
| of Example 1 | binder | of the film | 1 day | days | days |
| 3.42 g of solid glyoxylic | 75 | Strongly | tacky | — | — |
| acid monohydrate | | opaque | | | |
| 6 g of n-butanol | | | | | |
| 0.4 g of demi-water | | | | | |
| (Reference) | | | | | |
| 2.05 g of solid glyoxylic | 45 | Slightly | tacky | 165 | 213 |
| acid monohydrate | | opaque | | | |
| 6 g of n-butanol | | | | | |
| 0.4 g of demi-water | | | | | |
| 1.45 g of solid glyoxylic | 32 | Clear | not | 168 | 220 |
| acid monohydrate | | | tacky | | |
| 6 g of n-butanol | | | | | |
| 0.4 g of demi-water | | | | | |
| 1.75 g of 50% aqueous | 24 | Clear | 85 | 203 | 249 |
| glyoxylic acid | | | | | |
| 6 g of n-butanol | | | | | |
| 1.17 g of 50% aqueous | 16 | Clear | 104 | 209 | 233 |
| glyoxylic acid | | | | | |
| 6 g of n-butanol | | | | | |

### EXAMPLE 5

The experiments performed in Example 4 were repeated with the water borne dispersion from Example 2. Formulations and results are given in Tables 3 and 4.

TABLE 3

| | Molar % | | | | |
|---|---|---|---|---|---|
| | glyoxylic | | Persoz hardness (s) | | |
| | acid versus | | at r.t. | | |
| | hydroxy | Appear- | | after | after |
| Added to 20 g dispersion | groups of | ance | after | 7 | 14 |
| of Example 1 | binder | of the film | 1 day | days | days |
| 5.62 g of 50% aqueous | 100 | Clear | 61 | 87 | 120 |
| glyoxylic acid | | | | | |
| 3.37 g of 50% aqueous | 60 | Clear | 75 | 143 | 205 |
| glyoxylic acid | | | | | |
| 2.40 g of 50% aqueous | 43 | Clear | 98 | 169 | 249 |
| glyoxylic acid | | | | | |
| 1.80 g of 50% aqueous | 32 | Clear | 101 | 166 | 246 |
| glyoxylic acid | | | | | |
| 1.20 g of 50% aqueous | 21 | Clear | 105 | 187 | 241 |
| glyoxylic acid | | | | | |
| 0.3 g of proglyde DMM | | | | | |

Proglyde DMM = dimethyl ether of dipropylene glycol

TABLE 4

| | | Persoz hardness (s) | | |
|---|---|---|---|---|
| | | after x days at room | | |
| Curing | Appearance | temperature | | xylene |
| conditions | of the film | 1 day | 7 days | spot test |

Added to 20 g dispersion of Example 2,
1.80 g of 50% aqueous glyoxylic acid

| | | | | |
|---|---|---|---|---|
| fresh formulation | | | | |
| 1 h at 80° C. | clear | 268 | — | resistant |
| 30 min at 60° C. | clear | 170 | 230 | |
| 3 months old | | | | |
| 1 h at 80° C. | clear | 275 | — | resistant |

Added to 20 g dispersion of Example 2,
1.20 g of 50% aqueous glyoxylic acid
0.3 g of Proglyde DMM

| | | | |
|---|---|---|---|
| fresh formulation | | | |
| 1 h at 80° C. | clear | 195 | — |
| 3 months old | | | |
| 1 h at 80° C. | clear | 190 | — |

We claim:

1. A cross-linkable resin composition which is obtainable from the reaction of glyoxylic acid and a hydroxy and/or epoxy group-containing polymer in the absence of amino-containing cross-linkers, characterized in that 0.05-0.6 mole equivalent of glyoxylic acid is used per mole hydroxy group, with the epoxy groups being calculated as two hydroxy groups.

2. The cross-linkable resin composition of claim 1 wherein the hydroxy and/or epoxy group-containing polymer is a (meth)acrylate polymer.

3. The cross-linkable resin of claim 1 wherein 0.15-0.45 mole equivalent, more preferably 0.20-0.35 mole equivalent, of glyoxylic acid is used per mole hydroxy group.
